(19) United States
(12) Patent Application Publication
(10) Pub. No.: US 2020/0282978 A1
(43) Pub. Date: Sep. 10, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Yasushi Shoda, Wako-shi (JP); Junpei Noguchi, Wako-shi (JP); Yuki Hara, Wako-shi (JP); Ryoma Taguchi, Tokyo (JP); Yuta Takada, Tokyo (JP)

(21) Appl. No.: 16/808,416

(22) Filed: Mar. 4, 2020

(30) Foreign Application Priority Data
Mar. 8, 2019 (JP) 2019-042865

(51) Int. Cl. B60W 30/06; B60W 60/00; B60W 10/04; B60W 10/20

(52) U.S. Cl. CPC B60W 30/06; B60W 60/0053; B60W 10/04; B60W 10/20; B60W 2552/05; B60W 2720/10; B60W 2720/12; B60W 2710/20; B60W 2540/215

(57) ABSTRACT

A vehicle control system includes a recognizer configured to recognize a surrounding environment of a vehicle, a driving controller configured to automatically perform at least one of speed control and steering control of the vehicle on the basis of a recognition result of the recognizer, a communicator configured to communicate with a terminal device, and a notificator configured to notify the terminal device of information according to a parking environment recognized by the recognizer using the communicator when the driving controller causes the vehicle to travel and stop at a vehicle stop position after the occupant has got off the vehicle.

### CROSS-REFERENCE TO RELATED APPLICATION

Priority is claimed on Japanese Patent Application No. 2019-042865, filed on Mar. 8, 2019, the content of which is incorporated herein by reference.

### BACKGROUND

### Field of the Invention

The present invention relates to a vehicle control system, a vehicle control method, and a storage medium.

### Description of Related Art

In recent years, research on automatic control of vehicles has been performed. In connection therewith, a technology of notifying a terminal device of an occupant of a position of a vehicle parked according to automated driving has been known (for example, Japanese Unexamined Patent Application, First Publication No. 2017-182263).

### SUMMARY

However, in the related art, even when the position of a parked vehicle can be ascertained, it is difficult to ascertain a parking environment of the vehicle, and convenience is not sufficient.

An aspect of the present invention has been made in view of such circumstances, and an object of the present invention is to provide a vehicle control system, a vehicle control method, and a storage medium capable of improving convenience.

The vehicle control system, the vehicle control method, and the storage medium according to the present invention adopt the following configurations.

(1) A vehicle control system according to an aspect of the present invention includes a recognizer configured to recognize a surrounding environment of a vehicle; a driving controller configured to automatically perform at least one of speed control and steering control of the vehicle on the basis of a recognition result of the recognizer; a communicator configured to communicate with a terminal device; and a notificator configured to notify the terminal device of information according to a parking environment recognized by the recognizer using the communicator when the driving controller causes the vehicle to travel and stop at a vehicle stop position after an occupant has got off the vehicle.

(2) In the aspect (1), the parking environment is at least one of a distance from a parking position of the vehicle to the occupant having the terminal device, and an opening distance from an opening and closing portion of the vehicle to a nearby target when the opening and closing portion of the vehicle has been opened.

(3) In the aspect (1), the notificator further notifies the terminal device of the occupant of information indicating the vehicle stop position.

(4) In the aspect (1), the notificator notifies the terminal device of the occupant of information for proposing getting-on of the occupant through automatic control of driving from the vehicle stop position when the parking environment recognized by the recognizer indicates that the opening distance from an opening and closing portion of the vehicle when the opening and closing portion of the vehicle has been opened to a nearby target is a distance shorter than a reference.

(5) In the aspect (1), the driving controller stops the vehicle at a position at which an opening distance from an opening and closing portion of the vehicle when the opening and closing portion of the vehicle has been opened to a nearby target is long, when a preference of the occupant acquired in advance indicates that the occupant prefers to cause the vehicle to leave according to manual driving.

(6) In the aspect (1), the driving controller stops the vehicle at a position close to place that the occupant stops by when a preference of the occupant acquired in advance indicates that the occupant prefers to cause the vehicle to leave according to manual driving.

(7) In the aspect (1), the notificator notifies the terminal device of information according to the parking environment recognized by the recognizer, in response to a vehicle leaving request received from the terminal device by the communicator.

(8) In the aspect (1), the notificator notifies the terminal device of information according to the parking environment recognized by the recognizer, in response to inquiry information received from the terminal device by the communicator.

(9) In the aspect (1), the notificator notifies the terminal device of the occupant of information for proposing vehicle leaving of the vehicle according to manual driving when the parking environment recognized by the recognizer is an environment in which it is easy for the vehicle to leave.

(10) A vehicle control method according to another aspect of the present invention includes recognizing, by a computer, a surrounding environment of a vehicle; automatically performing, by the computer, at least one of speed control and steering control of the vehicle on the basis of a recognition result; communicating, by the computer, with a terminal device; and notifying, by the computer, the terminal device of information according to a recognized parking environment when the vehicle is caused to travel and stop at a vehicle stop position after an occupant has got off the vehicle.

(11) A storage medium according to still another aspect of the present invention is a non-transitory computer-readable storage medium storing a program, the program causing a computer to: recognize a surrounding environment of a vehicle; automatically perform at least one of speed control and steering control of the vehicle on the basis of a recognition result; communicate with a terminal device; and notify the terminal device of information according to a recognized parking environment when the vehicle is caused to travel and stop at a vehicle stop position after an occupant has got off the vehicle.

According to the aspects (1) to (11), it is possible to improve convenience for the occupant.

According to the aspect (3), it is possible to further improve convenience for the occupant.

According to the aspect (4), it is possible to cause the vehicle to safely leave according to automated driving in a narrow parking environment.

According to the aspects (5) and (6), it is possible to propose leaving of the vehicle according to manual driving in an environment in which it is easy for the occupant to cause the vehicle to leave.

According to the aspects (7) and (8), it is possible to provide the parking environment to the occupant at an appropriate time.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram schematically illustrating a scene in which a self-propelled parking event is executed.

FIG. 4 is a diagram illustrating an example of a configuration of a parking lot management device.

FIG. 5 is a diagram illustrating an example of a first execution screen of a notification application that is executed in a terminal device.

FIG. 6 is a diagram illustrating an example of content of schedule information.

FIG. 7 is a diagram illustrating an example of a recognition result of a recognizer.

FIG. 8 is a diagram illustrating an example of a second execution screen that is displayed on the terminal device when a space around a host vehicle is narrow.

FIG. 9 is a diagram illustrating an example of a third execution screen that is displayed on the terminal device when the space around the host vehicle is wide.

FIG. 10 illustrates an example of a fourth execution screen that is displayed on the terminal device when an inquiry about a parking environment of the host vehicle is performed according to the notification application.

FIG. 11 is a diagram schematically illustrating a process of selecting a parking space.

FIG. 12 is a flowchart illustrating a series of flows of a process in which a notificator notifies a terminal device of information on a parking environment.

FIG. 13 is a flowchart illustrating a series of flows of a process relevant to vehicle leaving of a host vehicle M according to a notification from the notificator.

FIG. 14 is a diagram illustrating an example of a hardware configuration of an automated driving control device according to the embodiment.

### DESCRIPTION OF EMBODIMENTS

Hereinafter, embodiments of a vehicle control device, a vehicle control method, and a storage medium of the present invention will be described with reference to the drawings.

### [Overall Configuration]

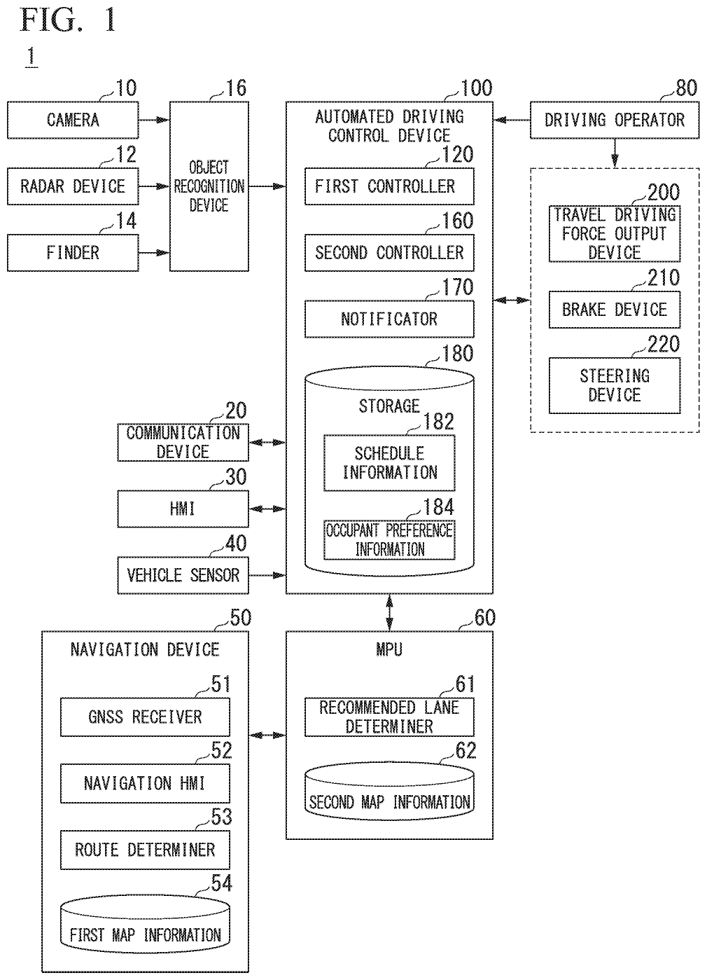

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle. A driving source thereof includes an internal combustion engine such as a diesel engine or a gasoline engine, an electric motor, or a combination thereof. The electric motor operates using power generated by a power generator connected to the internal combustion engine or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices or equipment are connected to each other by a multiplex communication line such as a controller area network (CAN) communication line, a serial communication line, a wireless communication network, or the like. The configuration shown in FIG. 1 is merely an example, and part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to any place on a vehicle in which the vehicle system 1 is mounted (hereinafter, a host vehicle M). In the case of forward imaging, the camera 10 is attached to an upper portion of a front windshield, a rear surface of a rearview mirror, or the like. The camera 10, for example, periodically and repeatedly images surroundings of the host vehicle M. The camera 10 may be a stereo camera.

The radar device 12 radiates radio waves such as millimeter waves to the surroundings of the host vehicle M and detects radio waves (reflected waves) reflected by an object to detect at least a position (a distance and orientation) of the object. The radar device 12 is attached to any place on the host vehicle M. The radar device 12 may detect a position and a speed of the object using a frequency modulated continuous wave (FM-CW) scheme.

The finder 14 is a light detection and ranging (LIDAR). The finder 14 radiates light to the surroundings of the host vehicle M and measures scattered light. The finder 14 detects a distance to a target on the basis of a time from light emission to light reception. The radiated light is, for example, pulsed laser light. The finder 14 is attached to any place on the host vehicle M.

The object recognition device 16 performs a sensor fusion process on detection results of some or all of the camera 10, the radar device 12, and the finder 14 to recognize a position, type, speed, and the like of the object. The object recognition device 16 supplies recognition results to the automated driving control device 100. The object recognition device 16 may output the detection results of the camera 10, the radar device 12, and the finder 14 as they are to the automated driving control device 100. The object recognition device 16 may be omitted from the vehicle system 1.

The communication device 20, for example, communicates with another vehicle or a parking lot management device (to be described below) present around the host vehicle M, or various server devices using a cellular network, a Wi-Fi network, Bluetooth (registered trademark), dedicated short range communication (DSRC), or the like.

The HMI 30 presents various types of information to an occupant of the host vehicle M and receives an input operation from the occupant. The HMI 30 includes various display devices, speakers, buzzers, touch panels, switches, keys, and the like.

The vehicle sensor 40 includes, for example, a vehicle speed sensor that detects a speed of the host vehicle M, an acceleration sensor that detects an acceleration, a yaw rate sensor that detects an angular speed around a vertical axis, and an orientation sensor that detects a direction of the host vehicle M.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 specifies a position of the host vehicle M on the basis of a signal received from a GNSS satellite. The position of the host vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the HMI 30 described above. The route determiner 53, for example, determines a route (hereinafter, an on-map route) from the position of the host vehicle M specified by the GNSS receiver 51 (or any input position) to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like.

The on-map route is output to the MPU 60. The navigation device 50 may perform route guidance using the navigation HMI 52 on the basis of the on-map route. The navigation device 50 may be realized, for example, by a function of a terminal device such as a smartphone or a tablet terminal possessed by the occupant. The navigation device 50 may transmit a current position and a destination to a navigation server via the communication device 20 and acquire the same route as the on-map route from the navigation server.

The MPU 60 includes, for example, a recommended lane determiner 61, and holds second map information 62 in a storage device such as an HDD or a flash memory. The recommended lane determiner 61 divides the on-map route provided from the navigation device 50 into a plurality of blocks (for example, divides the route every 100 [m] in a traveling direction of the vehicle) and determines a recommended lane for each block by referring to the second map information 62. The recommended lane determiner 61 determines in which lane from the left the host vehicle M travels.

The recommended lane determiner 61 determines the recommended lane so that the host vehicle M can travel on a reasonable route for progression to a branch destination when there is a branch place in the on-map route.

The second map information 62 is map information with higher accuracy than the first map information 54. The second map information 62 includes, for example, information on a center of the lane or information on a boundary of the lane. Further, the second map information 62 may include road information, traffic regulation information, address information (an address and postal code), facility information, telephone number information, and the like. The second map information 62 may be updated at any time by the communication device 20 communicating with another device.

The driving operator 80 includes, for example, an accelerator pedal, a brake pedal, a shift lever, a steering wheel, a variant steer, a joystick, and other operators. A sensor that detects the amount of operation or the presence or absence of operation is attached to the driving operator 80, and a detection result thereof is output to the automated driving control device 100 or some or all of the travel driving force output device 200, the brake device 210, and the steering device 220.

The automated driving control device 100 includes, for example, a first controller 120, a second controller 160, a notificator 170, and a storage 180. The first controller 120 and the second controller 160 are realized, for example, by a processor such as a central processing unit (CPU) or a graphics processing unit (GPU) executing a program (software). Further, some or all of these components may be realized by hardware (a circuit portion; including circuitry) such as a large scale integration (LSI), an application specific integrated circuit (ASIC), a field-programmable gate array (FPGA) or a graphics processing unit (GPU) or may be realized by software and hardware in cooperation. The program may be stored in a storage device (a storage device having a non-transitory storage medium) such as an HDD or a flash memory of the automated driving control device 100 in advance or may be stored in a detachable storage medium such as a DVD or a CD-ROM and installed in the HDD or the flash memory of the automated driving control device 100 by the storage medium (the non-transitory storage medium) being mounted in a drive device. Schedule information 182 and occupant preference information 184 are stored in the storage 180. Details of the schedule information 182 and the occupant preference information 184 will be described below.

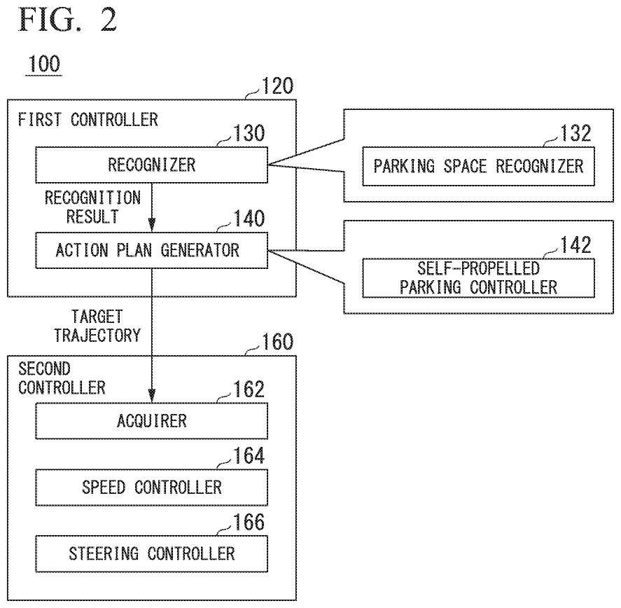

FIG. 2 is a functional configuration diagram of the first controller 120, and the second controller 160. The first controller 120 includes, for example, a recognizer 130 and an action plan generator 140. The first controller 120 realizes, for example, a function using artificial intelligence (AI) and a function using a previously given model in parallel. For example, a function of “recognizing an intersection” may be realized by recognition of the intersection using deep learning or the like and recognition based on previously given conditions (there is a signal which can be subjected to pattern matching, a road sign, or the like) being executed in parallel and scored for comprehensive evaluation. Accordingly, the reliability of automated driving is guaranteed.

The recognizer 130 recognizes a state such as a position, a speed, or an acceleration of an object around the host vehicle M on the basis of information input from the camera 10, the radar device 12, and the finder 14 via the object recognition device 16. The position of the object, for example, is recognized as a position at absolute coordinates with a representative point (a centroid, a drive shaft center, or the like) of the host vehicle M as an origin, and is used for control. The position of the object may be represented by a representative point such as a centroid or a corner of the object or may be represented by a represented area. The “state” of the object may include an acceleration or jerk of the object, or an “action state” (for example, whether or not the object is changing lanes or is about to change lanes).

The recognizer 130 recognizes, for example, a lane in which the host vehicle M is traveling (travel lane). For example, the recognizer 130 compares a pattern of a road marking line (for example, an arrangement of a solid line and a broken line) obtained from the second map information 62 with a pattern of a road marking line around the host vehicle M recognized from an image captured by the camera 10 to recognize the travel lane. The recognizer 130 may recognize not only the road marking lines but also a traveling road boundary (a road boundary) including the road marking line, a road shoulder, a curb, a median strip, a guard rail, or the like to recognize the travel lane. In this recognition, the position of the host vehicle M acquired from the navigation device 50 or a processing result of an INS may be additionally considered. Further, the recognizer 130 may recognize a temporary stop line, an obstacle, a red light, a toll gate, and other road events.

The recognizer 130 recognizes a position or posture of the host vehicle M with respect to a travel lane when recognizing the travel lane. The recognizer 130 may recognize, for example, a deviation of a reference point of the host vehicle M from a center of the lane and an angle formed between a traveling direction of the host vehicle M and a line connecting the center of the lane as the relative position and posture of the host vehicle M with respect to the travel lane. Instead, the recognizer 130 may recognize, for example, a position of the reference point of the host vehicle M with respect to any one of side end portions (the road marking line or the road boundary) of the travel lane as the relative position of the host vehicle M with respect to the travel lane.

The recognizer 130 includes a parking space recognizer 132 that is activated in a self-propelled parking event to be described below. Details of a function of the parking space recognizer 132 will be described below.

In principle, the action plan generator 140 generates a target trajectory along which the host vehicle M will travel in the future automatically (without depending on an operation of a driver) so that the host vehicle M can travel on the recommended lane determined by the recommended lane determiner 61 and cope with a surrounding situation of the host vehicle M. The target trajectory includes, for example, a speed element. For example, the target trajectory is represented as a sequence of points (trajectory points) to be reached by the host vehicle M. The trajectory point is a point that the host vehicle M is to reach for each predetermined travel distance (for example, several meters) at a road distance, and a target speed and a target acceleration at every predetermined sampling time (for example, every several tenths of a [sec]) are separately generated as a part of the target trajectory. The trajectory point may be a position that the host vehicle M is to reach at the sampling time at every predetermined sampling time. In this case, information on the target speed or the target acceleration is represented by the interval between the trajectory points.

When the action plan generator 140 generates the target trajectory, the action plan generator 140 may set an event of automated driving. Examples of the automated driving event include a constant speed traveling event, a low speed following driving event, a lane changing event, a branching event, a merging event, a takeover event, and a self-propelled parking event in which a vehicle travels in an unmanned manner and is parked in valet parking or the like. The action plan generator 140 generates a target trajectory according to an activated event. The action plan generator 140 includes a self-propelled parking controller 142 that is activated when the self-propelled parking event is performed. Details of a function of the self-propelled parking controller 142 will be described below.

The second controller 160 controls the travel driving force output device 200, the brake device 210, and the steering device 220 so that the host vehicle M passes through the target trajectory generated by the action plan generator 140 at a scheduled time.

Referring back to FIG. 2, the second controller 160 includes, for example, an acquirer 162, a speed controller 164, and a steering controller 166. The acquirer 162 acquires information on the target trajectory (trajectory points) generated by the action plan generator 140 and stores the information on the target trajectory in a memory (not illustrated). The speed controller 164 controls the travel driving force output device 200 or the brake device 210 on the basis of the speed element incidental to the target trajectory stored in the memory. The steering controller 166 controls the steering device 220 according to a degree of bend of the target trajectory stored in the memory.

Processes of the speed controller 164 and the steering controller 166 are realized by, for example, a combination of feedforward control and feedback control. For example, the steering controller 166 executes a combination of feedforward control according to a curvature of a road in front of the host vehicle M and feedback control based on a deviation from the target trajectory.

The notificator 170 notifies the terminal device TM of the occupant of the host vehicle M of information according to the parking environment of the host vehicle M recognized by the recognizer 130. The terminal device TM is realized by, for example, a portable communication terminal device such as a smartphone, a portable personal computer such as a tablet computer (tablet PC), or the like. The notificator 170 communicates with the terminal device TM using a cellular network, a Wi-Fi network, Bluetooth, a WAN, a LAN, the Internet, or the like by means of the communication device 20, to notify the occupant of the host vehicle M of various types of information. In the following description, the occupant of the host vehicle M is also simply referred to as an “occupant.”

The travel driving force output device 200 outputs a travel driving force (torque) for traveling of the vehicle to the driving wheels. The travel driving force output device 200 includes, for example, a combination of an internal combustion engine, an electric motor, a transmission, and the like, and an electronic control unit (ECU) that controls these. The ECU controls the above configuration according to information input from the second controller 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second controller 160 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder, as a backup. The brake device 210 is not limited to the configuration described above and may be an electronically controlled hydraulic brake device that controls the actuator according to information input from the second controller 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second controller 160 or information input from the driving operator 80 to change the direction of the steerable wheels.

### [Self-Propelled Parking Event-at Time of Vehicle Entrance]

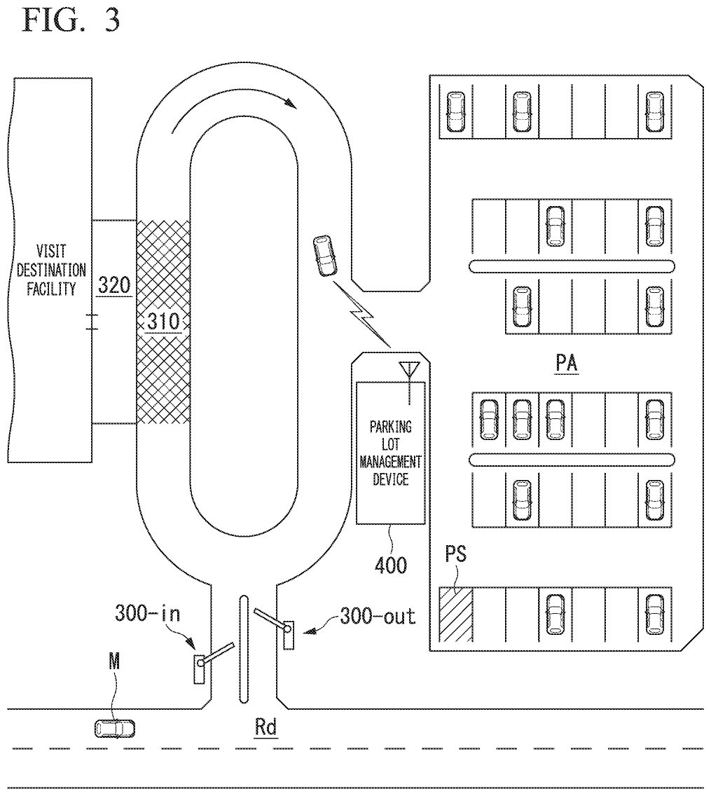

The self-propelled parking controller 142 parks the host vehicle M in the parking space on the basis of information acquired from the parking lot management device 400 by the communication device 20, for example. FIG. 3 is a diagram schematically illustrating a scene in which the self-propelled parking event is executed. Gates 300-in and 300-out are provided on a route from a road Rd to a visit destination facility. The host vehicle M advances to a stop area 310 through the gate 300-in according to manual driving or automated driving. The stop area 310 faces a getting-on and off area 320 connected to the visit destination facility. An eave for avoiding rain or snow is provided in the getting-on and off area 320. The visit destination facility is an example of “a place that the occupant stops by.”

After the occupant alights in the stop area 310, the host vehicle M starts unmanned automated driving and starts the self-propelled parking event to move to the parking space PS in a parking lot PA. A start trigger of the self-propelled parking event may be, for example, any operation of an occupant, or may be wireless reception of a predetermined signal from the parking lot management device 400. When the self-propelled parking controller 142 starts the self-propelled parking event, the self-propelled parking controller 142 controls the communication device 20 such that a parking request is transmitted to the parking lot management device 400. The host vehicle M moves from the stop area 310 to the parking lot PA according to guidance of the parking lot management device 400 or while performing its own sensing.

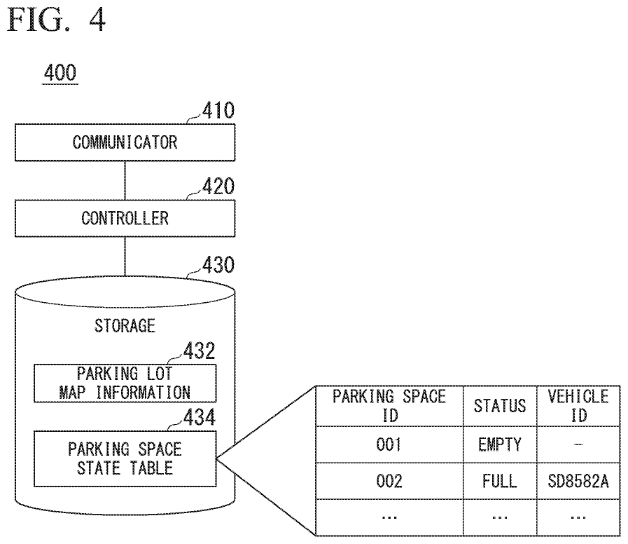

FIG. 4 is a diagram illustrating an example of a configuration of the parking lot management device 400. The parking lot management device 400 includes, for example, a communicator 410, a controller 420, and a storage 430. The storage 430 stores information such as parking lot map information 432 and a parking space state table 434.

The communicator 410 wirelessly communicates with the host vehicle M or other vehicles. The controller 420 guides the vehicle to the parking space PS on the basis of the information acquired by communicator 410 and the information stored in storage 430. The parking lot map information 432 is information that geometrically represents a structure of the parking lot PA. The parking lot map information 432 includes coordinates for each parking space PS.

The parking space state table 434 is, for example, a table in which a state indicating whether the parking space is in an empty state or a full (parked) state and a vehicle ID that is identification information of parked vehicles when the parking space is full are associated with a parking space ID, which is identification information of the parking space PS.

When the communicator 410 receives the parking request from the vehicle, the controller 420 extracts the parking space PS that is in an empty state by referring to the parking space state table 434, acquires a position of the extracted parking space PS from the parking lot map information 432, and transmits a suitable route to the acquired position of the parking space PS to the vehicle using the communicator 410. The controller 420 instructs a specific vehicle, for example, to stop or slow down, as necessary, on the basis of positional relationships between a plurality of vehicles so that the vehicles do not advance to the same position at the same time.

In a vehicle (hereinafter, referred to as the host vehicle M) that has received the route, the self-propelled parking controller 142 generates a target trajectory based on the route. When the host vehicle M approaches the parking space PS, which is a target, the parking space recognizer 132 recognizes parking frame lines or the like that partition the parking space PS, recognizes a specific position of the parking space PS, and provides the position to the self-propelled parking controller 142. The self-propelled parking controller 142 receives the position, corrects the target trajectory, and parks the host vehicle M in the parking space PS.

[Self-Propelled Parking Event-at Time of Vehicle Leaving]

The self-propelled parking controller 142 and the communication device 20 remain in an operating state even when the host vehicle M is parked. The self-propelled parking controller 142 activates a system of the host vehicle M and moves the host vehicle M to the stop area 310, for example, when the communication device 20 receives a pick-up request from the terminal device TM. In this case, the self-propelled parking controller 142 controls the communication device 20 such that a start request is transmitted to the parking lot management device 400. The controller 420 of the parking lot management device 400 instructs a specific vehicle, for example, to stop or slow down, as necessary, on the basis of a positional relationship among a plurality of vehicles so that the vehicles do not advance to the same position at the same time, similar to the time of vehicle entrance. When the host vehicle M is moved to the stop area 310 and an occupant gets on the host vehicle M, the self-propelled parking controller 142 stops an operation, and then, manual driving or automated driving by another functional unit is started.

The present invention is not limited to the above, and the self-propelled parking controller 142 may find a parking space in an empty state by itself on the basis of detection results of the camera 10, the radar device 12, the finder 14, or the object recognition device 16 without depending on communication, and park the host vehicle M in the found parking space.

### [Notification of Parking Environment]

The notificator 170 acquires a recognition result of the recognizer 130, for example, when the self-propelled parking controller 142 parks (stops) the host vehicle M in the parking lot PA according to the self-propelled parking event. The notificator 170 acquires the parking environment of the host vehicle M on the basis of the acquired recognition result, and notifies the terminal device TM of information on the acquired parking environment. The information on the parking environment includes, for example, at least some of proximity from a parking position of the host vehicle M to the visited destination facility, ease of getting-on of the host vehicle M, ease of alighting from the host vehicle M, ease of loading luggage into the host vehicle M, ease of unloading luggage from the host vehicle M, and ease of leaving of the host vehicle M. The notificator 170 notifies the terminal device TM of information according to the acquired parking environment of the terminal device TM.

The information of which the notificator 170 notifies the terminal device TM is some or all of the following.

(1) Information indicating the position at which the host vehicle M has been parked (stopped)

(2) information indicating a space around the host vehicle M

(3) Information for proposing a method for leaving from the host vehicle M

[(1) Information Indicating Position at which Vehicle M has been Parked]

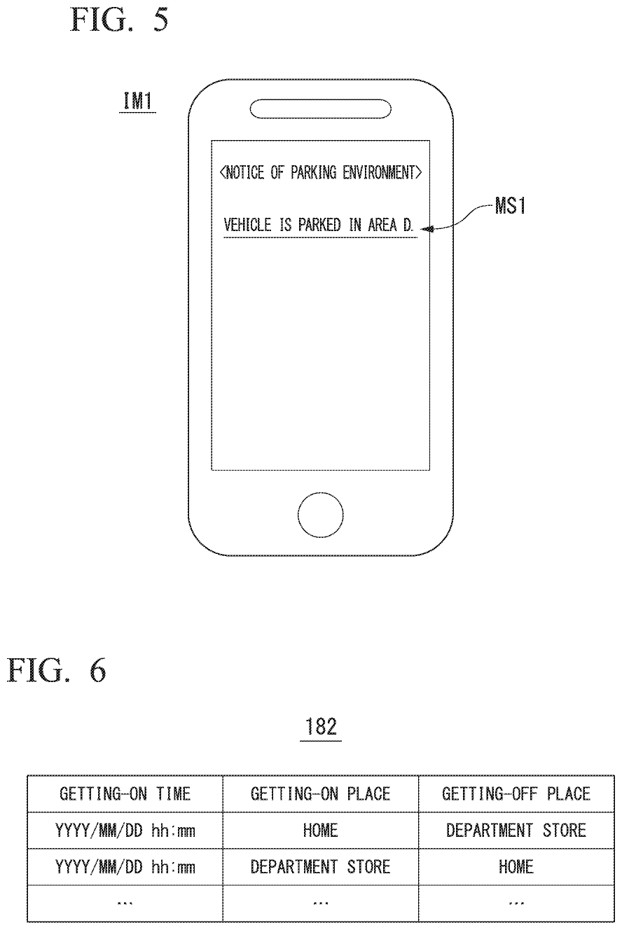

The notificator 170 notifies the terminal device TM of information indicating the position at which the host vehicle M has been parked on the basis of the recognition result of the recognizer 130 at a timing when the self-propelled parking controller 142 has parked the host vehicle M in the parking lot PA according to the self-propelled parking event. FIG. 5 is a diagram illustrating an example of a first execution screen IM1 of a notification application that is executed in the terminal device TM. The notification application is an application that is executed in the terminal device TM, and is an application for notifying the occupant of information acquired from the automated driving control device 100. The first execution screen IM1 includes, for example, a message MS1 indicating the position at which the host vehicle M has been parked.

Hereinafter, it is assumed that codes (for example, area A or area B) that allow the parking position to be easily ascertained are determined in the parking lot PA in advance, and assigned to structures (for example, a column or a wall) of the parking lot PA in each area. In this case, the recognizer 130 analyzes the image captured by the camera 10 and recognizes the code assigned to the position (an area) in which the host vehicle M has been parked. The notificator 170 notifies the terminal device TM of the code recognized by the recognizer 130 as information indicating the position at which the host vehicle M has been parked. The terminal device TM receives the information from the notificator 170, generates the first execution screen IM1 including “The vehicle has been parked in area D” for notifying the occupant of an area in which the host vehicle M has been parked on the basis of the received information (the illustrated message MS1), and displays the first execution screen IM1 on the display.

The notificator 170 may generate the first execution screen IM1 and notify the terminal device TM of a relevant image as the information indicating the position at which the host vehicle M has been parked. The notificator 170 may notify the terminal device TM of information indicating a current position of the host vehicle M at the time of parking detected by the GNSS receiver 51 as the information indicating the position at which the host vehicle M has been parked. In this case, the terminal device TM, for example, generates an image in which information indicating the current position of the host vehicle M is shown on a map, as the first execution screen IM1, in cooperation with a map application, and displays the image on the display. The notificator 170 may notify the terminal device TM of an image obtained by the camera 10 imaging an area around the position at which the host vehicle M has been parked, as information indicating the position at which the host vehicle M has been parked.

Thereby, the notificator 170 can reduce a time and effort for the occupant to search for the host vehicle M. The notificator 170 can allow the occupant to easily determine whether to cause the host vehicle M to leave according to the self-propelled parking event relevant to vehicle leaving of the self-propelled parking controller 142 or whether to cause the host vehicle M to leave according to driving (manual driving) of the occupant.

[(2) Information indicating space around host vehicle M]

The notificator 170 notifies the terminal device TM of information indicating a space around the host vehicle M at a timing when the host vehicle M leaves the parking lot PA. The self-propelled parking controller 142 executes, for example, the self-propelled parking event relevant to vehicle leaving on the basis of the schedule information 182. FIG. 6 is a diagram illustrating an example of content of the schedule information 182. The schedule information 182 is, for example, information in which a getting-on place at which the occupant gets on the host vehicle M, a getting-off place at which the occupant gets off the host vehicle M, and a date and time when the occupant gets on at the getting-on place (hereinafter, a getting-on date and time) are associated with each other. The self-propelled parking controller 142 starts the self-propelled parking event relevant to vehicle leaving at a date and time included in the schedule information 182, for example. When a current time is a time slightly before (for example, several minutes before) the getting-on date and time included in the schedule information 182, the notificator 170 notifies the terminal device TM of the information indicating the space around the host vehicle M, to prompt a determination as to whether the host vehicle M is caused to leave under the control of the self-propelled parking controller 142 or according to manual driving.

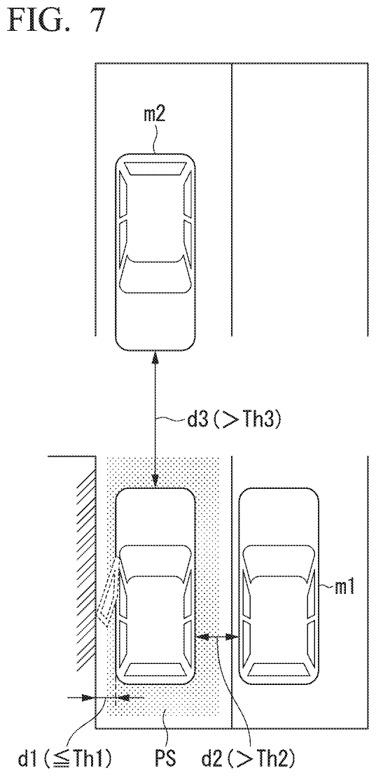

FIG. 7 is a diagram illustrating an example of the recognition result of the recognizer 130. The recognizer 130 and the communication device 20 remain in an operating state even when the host vehicle M is parked. The notificator 170 determines whether the space around the host vehicle M is wide on the basis of the recognition result of the surrounding environment of the host vehicle M recognized by the recognizer 130 at a time slightly before a getting-on time included in the schedule information 182. For example, when the recognition result of the recognizer 130 shows a distance from a door (an opening and closing portion) of a driver seat to a nearest target (that is, a nearby target) (hereinafter, a first distance d1) is equal to or smaller than a predetermined threshold value (hereinafter, a first threshold value Th1) in a space necessary when the door of the driver seat is opened, the notificator 170 determines that the space around the host vehicle M is narrow. The first threshold value Th1 is, for example, a value indicating about tens of centimeters. In FIG. 7, since the recognition result of the recognizer 130 indicates that the first distance d1 is equal to or smaller than the first threshold value Th1, the notificator 170 notifies the terminal device TM of information indicating that the space around the host vehicle M is narrow. In the space necessary when the door of the driver seat is opened, the distance from the door to the nearest target is an example of an “opening distance.”

For example, when the recognition result of the recognizer 130 indicates that a distance from a door of a passenger seat to a nearest target (hereinafter, a second distance d2) is equal to or smaller than a predetermined threshold value (hereinafter, a second threshold value Th2) in a space necessary when the door of the passenger seat is opened, the notificator 170 may determine that the space around the host vehicle M is narrow. The second threshold value Th2 is, for example, a value indicating about tens of centimeters. The first threshold value Th1 and the second threshold value Th2 may be the same value. In FIG. 7, since the recognition result of the recognizer 130 indicates that a distance to another vehicle m1 parked next to the host vehicle M (that is, the second distance d2) is greater than the second threshold value Th2, the notificator 170 notifies the terminal device TM of information indicating that the space around the host vehicle M is wide. In the space necessary when the door of the passenger seat is opened, the distance from the door to the nearest target is an example of an “opening distance.”

For example, when the recognition result of the recognizer 130 indicates that a distance from the host vehicle M to a nearest target (hereinafter, a third distance d3) is equal to or smaller than a predetermined threshold value (hereinafter, a third threshold value Th3) in a space virtually extending in front of the host vehicle M in a situation in which the host vehicle M travels forward and leaves the parking space PS (that is, is parked backward), the notificator 170 may determine that the space around the host vehicle M is narrow. The third threshold value Th3 is, for example, a value indicating about tens of centimeters to hundreds of centimeters. In FIG. 7, since the recognition result of the recognizer 130 indicates that a distance to another vehicle m2 parked in front of the host vehicle M (that is, the third distance d3) is greater than the third threshold value Th3, the notificator 170 notifies the terminal device TM of information indicating that the space around the host vehicle M is wide.

For example, when the recognition result of the recognizer 130 indicates that a distance from the host vehicle M to a nearest target (hereinafter, a fourth distance d4 (not illustrated)) is equal to or smaller than a predetermined threshold value (hereinafter, a fourth threshold value Th4) in a space virtually extending to the rear of the host vehicle M in a situation in which the host vehicle M travels backward and leaves the parking space PS (that is, is parked forward), the notificator 170 may determine that the space around the host vehicle M is narrow. The fourth threshold value Th4 is, for example, a value indicating about tens of centimeters to hundreds of centimeters. The third threshold value Th3 and the fourth threshold value Th4 may be the same value.

The notificator 170 may determine that the space around the host vehicle M is narrow on the basis of some or all of the determinations based on the first distance d1, the second distance d2, the third distance d3, and the fourth distance d4. Hereinafter, a description will be made assuming that the notificator 170 determines that the space around the host vehicle M is narrow when the notificator 170 has determined that the space around the host vehicle M is narrow in at least one of the determinations based on the first distance d1, the second distance d2, the third distance d3, or the fourth distance d4.

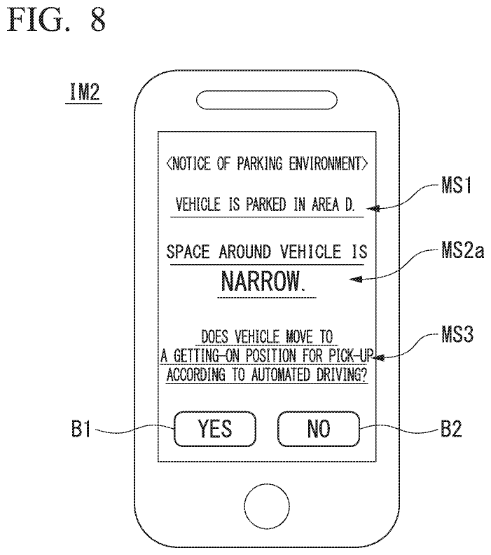

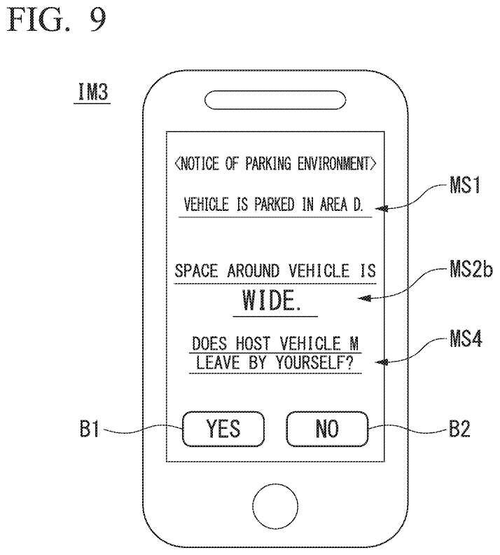

FIG. 8 is a diagram illustrating an example of a second execution screen IM2 that is displayed on the terminal device TM when the space around the host vehicle M is small. FIG. 9 is a diagram illustrating an example of a third execution screen IM3 that is displayed on the terminal device TM when the space around the host vehicle M is wide. The second execution screen IM2 includes, for example, the message MS1, and a message MS2 indicating a determination result of the space around the host vehicle M, which is a message MS2a when the determination result indicates that the space is narrow. The message MS2a has, for example, content such as “The space around the vehicle is narrow.” The third execution screen IM3 includes, for example, the message MS1 and a message MS2 indicating a determination result of the space around the host vehicle M, which is a message MS2b when the determination result indicates that the space is wide. The message MS2b has, for example, content such as “The space around the vehicle is wide.”

Thereby, the notificator 170 can allow the occupant to easily determine whether to cause the host vehicle M to leave according to the self-propelled parking event relevant to vehicle leaving of the self-propelled parking controller 142 or whether to cause the host vehicle M to leave according to manual driving.

[(3) Information for proposing a method for leaving of host vehicle M]

The second execution screen IM2 includes a message MS3 for inquiring about whether or not the host vehicle M will not be caused to leave according to manual driving and will be caused to leave according to the self-propelled parking event relevant to leaving of the self-propelled parking controller 142 since the space around the host vehicle M is narrow. The message MS3 has, for example, content such as “Does the vehicle move to a getting-on position for pick-up according to automated driving?” The second execution screen IM2 includes a button B1 indicating that the occupant agrees with the message MS3, and a button B2 indicating that the occupant does not agree with the message MS. When a process of selecting the button B1 is performed in the terminal device TM, the self-propelled parking controller 142 causes the host vehicle M to leave according to the self-propelled parking event relevant to vehicle leaving. When a process of selecting the button B2 is performed in the terminal device TM, the self-propelled parking controller 142 does not execute the self-propelled parking event relevant to vehicle leaving, and the occupant causes the host vehicle M to leave according to manual driving.

The third execution screen IM3 includes a message MS4 for inquiring about whether or not the host vehicle M is not caused to leave according to the self-propelled parking event relevant to leaving of the self-propelled parking controller 142 and is caused to leave according to manual driving since the space around the host vehicle M is wide, and buttons B1 and B2. The message MS4 has, for example, content such as “Does the host vehicle M leave by yourself?” When a process of selecting the button B1 is performed in the terminal device TM, the self-propelled parking controller 142 does not execute the self-propelled parking event relevant to vehicle leaving, and the occupant causes the host vehicle M to leave according to manual driving. When a process of selecting the button B2 is performed in the terminal device TM, the self-propelled parking controller 142 causes the host vehicle M to leave according to the self-propelled parking event relevant to vehicle leaving.

[Timing at which Terminal Device TM is Notified of Information According to Parking Environment]

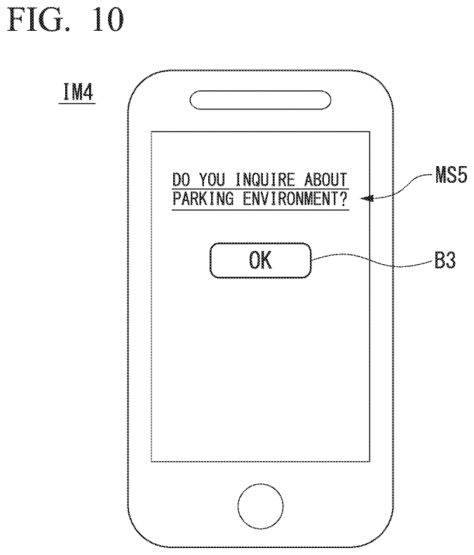

A case in which the notificator 170 notifies the terminal device TM of the information according to the parking environment at the timing when the host vehicle M has parked in the parking lot PA or at the timing when the host vehicle M leaves the parking lot PA has been described above, but the present invention is not limited thereto. The notificator 170 may notify the terminal device TM of the information according to the parking environment on the basis of an instruction of the occupant, for example. FIG. 10 is an example of a fourth execution screen IM4 that is displayed on the terminal device TM when an inquiry about the parking environment of the host vehicle M is performed using a notification application. The fourth execution screen IM4 includes, for example, a message MS5 for inquiring of the occupant about whether or not an inquiry about the parking environment of the host vehicle M is necessary, and a button B3 for instructing execution of the inquiry about the parking environment of the host vehicle M. The message MS5 is, for example, “Do you want to inquire about the parking environment?” When a process of selecting the button B3 is performed in the terminal device TM, the notificator 170 notifies the terminal device TM of the information such as (1) to (3) described above.

The notificator 170 may notify the terminal device TM of information such as (1) to (3) described above at a timing when a vehicle leaving request has been received from the terminal device TM.

### [Parking Position]

The self-propelled parking controller 142 may select the parking space PS of the parking lot PA on the basis of the occupant preference information 184 and park the host vehicle M. The occupant preference information 184 is information indicating preferences of the occupant. The preferences include, for example, whether or not the occupant prefers to cause the host vehicle M to leave according to manual driving. For example, when the occupant preference information 184 indicates that the occupant prefers to cause the host vehicle M to leave according to manual driving, the self-propelled parking controller 142 parks the host vehicle M in the parking space PS in which it is easy for the occupant to cause the host vehicle M to leave, among the parking spaces PS.

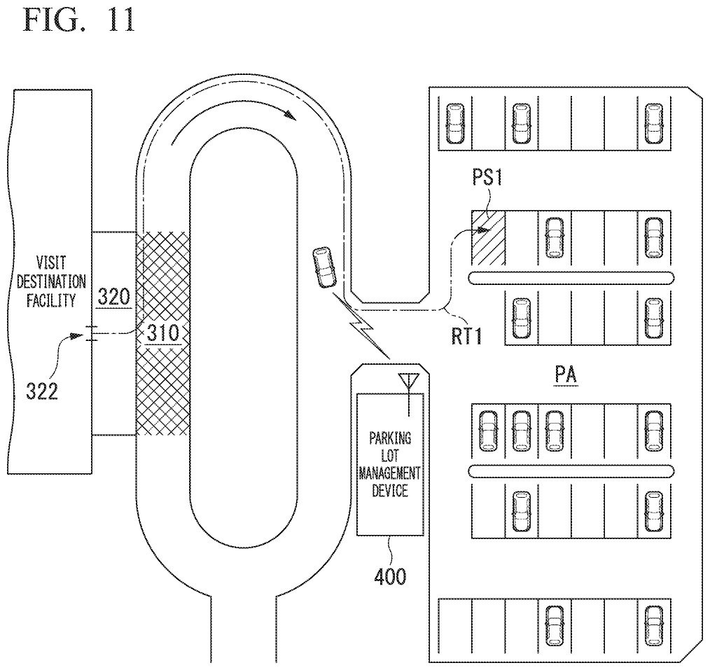

For example, when the occupant preference information 184 indicates that the occupant prefers to cause the host vehicle M to leave according to manual driving, the self-propelled parking controller 142 parks the vehicle M in the parking space PS close to the visit destination facility at the time of execution of the self-propelled parking event relevant to vehicle entrance. FIG. 11 is a diagram schematically illustrating a process of selecting the parking space PS. First, the self-propelled parking controller 142 controls the communication device 20 such that information indicating the parking space PS closest to the visited destination facility is included in the parking request and the resultant parking request is transmitted to the parking lot management device 400.

The self-propelled parking controller 142, for example, may include, in the parking request, position information indicating a position of the getting-on and off area 320 in the visit destination facility, a position of a doorway 322 of the visit destination facility, or a position of a centroid of the visit destination facility indicated in a map on which the visit destination facility is indicated as a point of interest (POI), and transmit the resultant parking request to the parking lot management device 400. For example, when the parking request including the position information is received from a vehicle such as the host vehicle M, the parking lot management device 400 selects a parking space PS closest to the position indicated by the position information. Hereinafter, it is assumed that the parking request includes position information indicating the position of the doorway 322. In this case, the parking lot management device 400 specifies a parking space PS1 close to the doorway 322 of the visit destination facility among the parking spaces PS in the empty state. The parking lot management device 400 specifies, for example, a parking space PS closest to the doorway 322 in a straight line distance, a parking space PS having the shortest route from the doorway 322, or the like as the parking space PS1. The parking lot management device 400 transmits a route RT1 that is a shortest route connecting the doorway 322 to the parking space PS1 to the automated driving control device 100 using the communicator 410. The self-propelled parking controller 142 causes the host vehicle M to travel to the parking space PS1 on the basis of the received route and parks the host vehicle M.

### [Operation Flow]

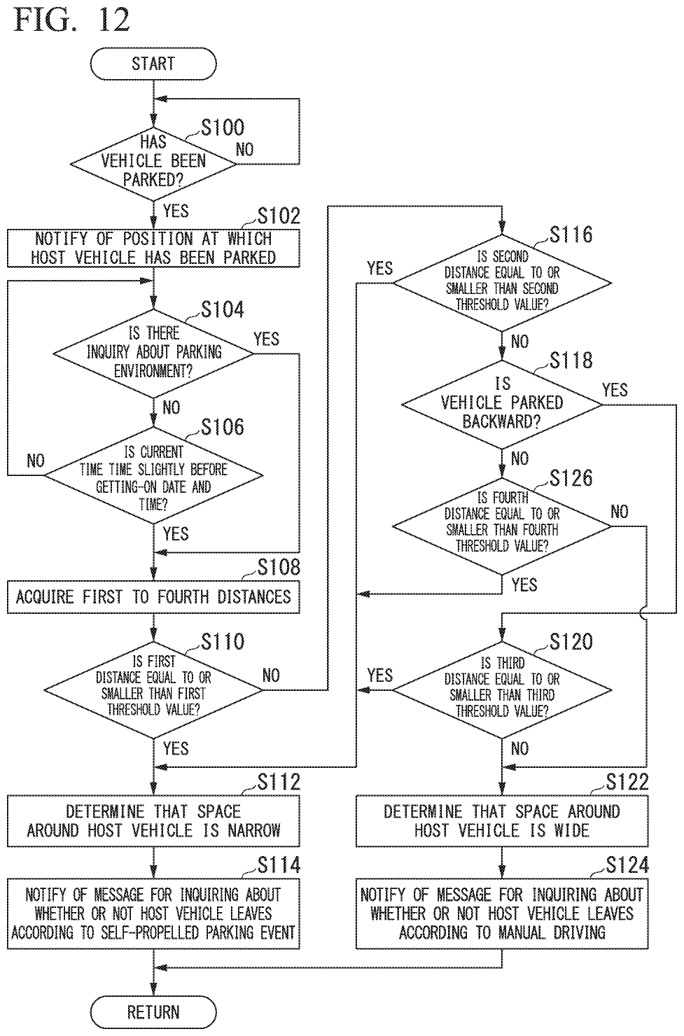

FIG. 12 is a flowchart illustrating a series of flows of a process in which the notificator 170 notifies the terminal device TM of information on a parking environment. First, the notificator 170 determines whether or not the self-propelled parking controller 142 has parked the host vehicle M in the parking lot PA according to the self-propelled parking event (step S100). The notificator 170 waits until the host vehicle M has been parked in the parking lot PA. When the host vehicle M has been parked in the parking lot PA, the notificator 170 notifies the terminal device TM of the information indicating the position at which the host vehicle M has been parked, on the basis of the recognition result of the recognizer 130 (step S102). Then, the notificator 170 determines whether or not there has been an inquiry about the parking environment from the terminal device TM (step S104). When there has been an inquiry about the parking environment from terminal device TM, the notificator 170 causes the process to proceed to step S108. When there has been no inquiry about the parking environment from the terminal device TM, the notificator 170 determines whether or not the current time is slightly before the getting-on date and time on the basis of the schedule information 182 (step S106). When the notificator 170 determines that the current time is not a time slightly before the getting-on date and time and proceeds to the process of step S104. When the notificator 170 determines that the current time is a time slightly before the getting-on date and time and proceeds to the process of step S108.

The notificator 170 acquires the first distance d1, the second distance d2, the third distance d3, and the fourth distance d4 on the basis of the recognition result of the recognizer 130 (step S108). The notificator 170 determines whether the acquired first distance d1 is equal to or smaller than the first threshold value Th1 (step S110). When the notificator 170 has determined that the first distance d1 is equal to or smaller than the first threshold value Th1, the notificator 170 determines that the space around the host vehicle M is narrow (step S112) and notifies the terminal device TM of the message MS3 for inquiring about whether or not to the host vehicle M leaves according to the self-propelled parking event of the self-propelled parking controller 142 (step S114).

When the notificator 170 has determined that the first distance d1 is greater than the first threshold value Th1, the notificator 170 determines whether the second distance d2 is equal to or smaller than the second threshold value Th2 (step S116). When the notificator 170 has determined that the second distance d2 is equal to or smaller than the second threshold value Th2, the notificator 170 determines that the space around the host vehicle M is narrow and proceeds to the process of step S112. When the notificator 170 has determined that the second distance d2 is greater than the second threshold value Th2, the notificator 170 determines whether the host vehicle M will be parked backward or forward on the basis of the recognition result of the recognizer 130 (step S118). When the notificator 170 has determined that the host vehicle M is parked backward, the notificator 170 determines whether or not the third distance d3 is equal to or smaller than the third threshold value Th3 (step S120). When the notificator 170 has determined that the third distance d3 is equal to or smaller than third threshold value Th3, notificator 170 determines that the space around the host vehicle M is narrow and proceeds to the process of step S112. When the notificator 170 has determined that the third distance d3 is greater than the third threshold value Th3, the notificator 170 determines that the space around the host vehicle M is wide (step S122) and notifies the terminal device TM of the message MS4 for inquiring about whether or not the host vehicle M is to leave according to manual driving (step S124). When the notificator 170 has determined that the host vehicle M is parked forward, the notificator 170 determines whether the fourth distance d4 is equal to or smaller than the fourth threshold value Th4 (step S126). When the notificator 170 has determined that the fourth distance d4 is equal to or smaller than the fourth threshold value Th4, the notificator 170 determines that the space around the host vehicle M is narrow and proceeds to the process of step S112. When the notificator 170 has determined that the fourth distance d4 is greater than the fourth threshold value Th4, the notificator 170 determines that the space around the host vehicle M is wide and proceeds to the process of step S122.

A case in which the notificator 170 determines that the space around the host vehicle M is wide only when all of the first distance d1, the second distance d2, the third distance d3, and the fourth distance d4 are greater than the predetermined threshold values (the first threshold value Th1 to the fourth threshold value Th4) in the flowchart illustrated in FIG. 12 has been described, but the present invention is not limited thereto. The notificator 170 may determine that the space around the host vehicle M is wide when some of the first distance d1, the second distance d2, the third distance d3, and the fourth distance d4 are greater than the predetermined threshold values. The notificator 170 may execute a process (step S118) of determining whether the host vehicle M is parked backward or forward in the process before step S108 and acquire the third distance d3 or the fourth distance d4 according to a determination result.

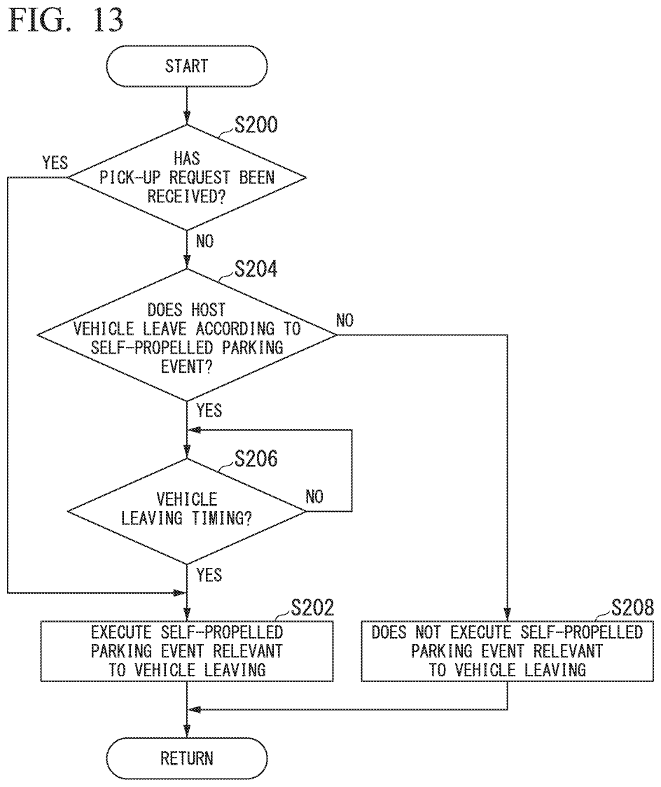

FIG. 13 is a flowchart illustrating a series of flows of a process relevant to leaving of the host vehicle M according to the notification from the notificator 170. First, the self-propelled parking controller 142 determines whether the pick-up request has been received from the terminal device TM (step S200). When the self-propelled parking controller 142 has determined that the pick-up request has been received from the terminal device TM, the self-propelled parking controller 142 executes a self-propelled parking event relevant to vehicle leaving and moves the host vehicle M to the stop area 310 (step S202). The self-propelled parking controller 142 determines whether or not the occupant has selected to leave the host vehicle M according to the self-propelled parking event relevant to vehicle leaving in response to the notification (for example, the messages MS3 to MS4) from the notificator 170 (step S204). For example, the self-propelled parking controller 142 determines whether the occupant has performed an operation indicating that the occupant agrees with the message MS3 for inquiring whether or not to cause the host vehicle M to leave according to the self-propelled parking event relevant to vehicle leaving or the occupant has performed an operation indicating that the occupant does not agree with the message MS4 for inquiring about whether or not to cause the host vehicle M to leave according to manual driving.

When the self-propelled parking controller 142 has determined that the occupant has selected leaving of the host vehicle M according to the self-propelled parking event relevant to vehicle leaving, the self-propelled parking controller 142 determines whether the current time is a leaving date and time (that is, a leaving timing) included in the schedule information 182 (step S206). The self-propelled parking controller 142 waits until the current time reaches the leaving timing. When the current time is the leaving timing, the self-propelled parking controller 142 proceeds to a process of step S202. When the self-propelled parking controller 142 has determined that the occupant has selected non-leaving of the host vehicle M according to the self-propelled parking event relevant to vehicle leaving (that is, the occupant has selected leaving of the host vehicle M according to manual driving), the self-propelled parking controller 142 does not execute the self-propelled parking event relevant to vehicle leaving (step S208).

In this case, the occupant causes the host vehicle M to leave according to manual driving.

### Conclusion of Embodiment

As described above, the automated driving control device 100 according to the embodiment includes a recognizer 130 configured to recognize the surrounding environment of the host vehicle M, a driving controller (the action plan generator 140 and the second controller 160) configured to automatically perform at least one of speed control and steering control of the host vehicle M on the basis of a recognition result of the recognizer 130, the communication device 20 configured to communicate with the terminal device TM, and the notificator 170 configured to notify the terminal device M of information according to a parking environment recognized by the recognizer 130 using the communication device 20 when the driving controller causes the host vehicle M to travel and stop at a vehicle stop position after an occupant has got off the host vehicle M. Therefore, it is possible to improve convenience for the occupant.

### [Hardware Configuration]

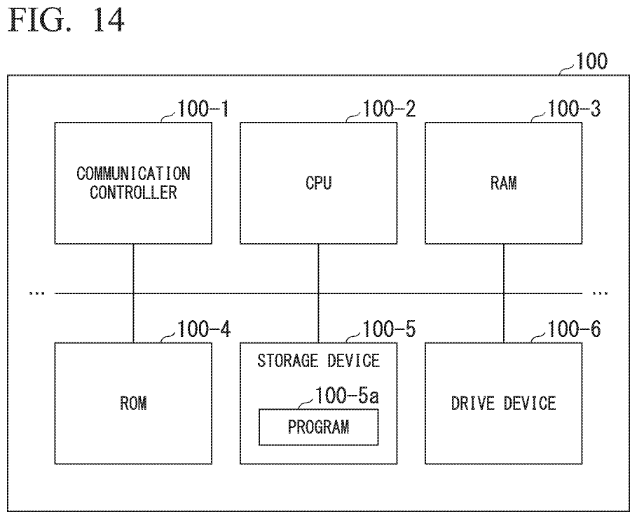

FIG. 14 is a diagram showing an example of a hardware configuration of the automated driving control device 100 according to the embodiment. As shown in FIG. 14, the automated driving control device 100 has a configuration in which a communication controller 100-1, a CPU 100-2, a random access memory (RAM) 100-3 that is used as a working memory, a read only memory (ROM) 100-4 that stores a boot program or the like, a storage device 100-5 such as a flash memory or a hard disk drive (HDD), a drive device 100-6, and the like are connected to each other by an internal bus or a dedicated communication line. The communication controller 100-1 communicates with components other than the automated driving control device 100. A program 100-5a to be executed by the CPU 100-2 is stored in the storage device 100-5. This program is developed in the RAM 100-3 by a direct memory access (DMA) controller (not shown) or the like and executed by the CPU 100-2. Thereby, some or all of the recognizer 130, the self-propelled parking controller 142, and the notificator 170 are realized.

The embodiments described above can be represented as follows.

A vehicle control device including a storage device storing a program, and a hardware processor, and configured to recognize a surrounding environment of a vehicle, automatically perform at least one of speed control and steering control of the vehicle on the basis of a recognition, communicate with a terminal device, and notify the terminal device of information according to a recognized parking environment when the vehicle is caused to travel and stop at a vehicle stop position after an occupant has got off the vehicle, by the hardware processor executing the program stored in the storage device.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description and is only limited by the scope of the appended claims.

What is claimed is:

1. A vehicle control system comprising:
a recognizer configured to recognize a surrounding environment of a vehicle;
a driving controller configured to automatically perform at least one of speed control and steering control of the vehicle on the basis of a recognition result of the recognizer;
a communicator configured to communicate with a terminal device; and
a notificator configured to notify the terminal device of information according to a parking environment recognized by the recognizer using the communicator when the driving controller causes the vehicle to travel and stop at a vehicle stop position after an occupant has got off the vehicle.

2. The vehicle control system according to claim 1, wherein the parking environment is at least one of a distance from a parking position of the vehicle to the occupant having the terminal device, and an opening distance from an opening and closing portion of the vehicle to a nearby target when the opening and closing portion of the vehicle has been opened.

3. The vehicle control system according to claim 1, wherein the notificator further notifies the terminal device of the occupant of information indicating the vehicle stop position.

4. The vehicle control system according to claim 1, wherein the notificator notifies the terminal device of the occupant of information for proposing getting-on of the occupant through automatic control of driving from the vehicle stop position when the parking environment recognized by the recognizer indicates that the opening distance from an opening and closing portion of the vehicle when the opening and closing portion of the vehicle has been opened to a nearby target is a distance shorter than a reference.

5. The vehicle control system according to claim 1, wherein the driving controller stops the vehicle at a position at which an opening distance from an opening and closing portion of the vehicle when the opening and closing portion of the vehicle has been opened to a nearby target is long, when a preference of the occupant acquired in advance indicates that the occupant prefers to cause the vehicle to leave according to manual driving.

6. The vehicle control system according to claim 1, wherein the driving controller stops the vehicle at a position close to place that the occupant stops by when a preference of the occupant acquired in advance indicates that the occupant prefers to cause the vehicle to leave according to manual driving.

7. The vehicle control system according to claim 1, wherein the notificator notifies the terminal device of information according to the parking environment recognized by the recognizer, in response to a vehicle leaving request received from the terminal device by the communicator.

8. The vehicle control system according to claim 1, wherein the notificator notifies the terminal device of information according to the parking environment recognized by the recognizer, in response to inquiry information received from the terminal device by the communicator.

9. The vehicle control system according to claim 1, wherein the notificator notifies the terminal device of the occupant of information for proposing vehicle leaving of the vehicle according to manual driving when the parking environment recognized by the recognizer is an environment in which it is easy for the vehicle to leave.

10. A vehicle control method comprising:
recognizing, by a computer, a surrounding environment of a vehicle;
automatically performing, by the computer, at least one of speed control and steering control of the vehicle on the basis of a recognition result;
communicating, by the computer, with a terminal device; and
notifying, by the computer, the terminal device of information according to a recognized parking environment when the vehicle is caused to travel and stop at a vehicle stop position after an occupant has got off the vehicle.

11. A non-transitory computer-readable storage medium storing a program, the program causing a computer to:
recognize a surrounding environment of a vehicle;
automatically perform at least one of speed control and steering control of the vehicle on the basis of a recognition result;
communicate with a terminal device; and
notify the terminal device of information according to a recognized parking environment when the vehicle is caused to travel and stop at a vehicle stop position after an occupant has got off the vehicle.
